(19) United States
(12) Patent Application Publication
(10) Pub. No.: US 2017/0289711 A1
(43) Pub. Date: Oct. 5, 2017

(54) HEARING DEVICE COMPRISING MODULAR ENGAGEMENT MEANS

(71) Applicant: Oticon Medical A/S, Smørum (DK)

(72) Inventor: Patrick MAAS, Smørum (DK)

(73) Assignee: Oticon Medical A/S, Smørum (DK)

(21) Appl. No.: 15/471,162

(22) Filed: Mar. 28, 2017

(30) Foreign Application Priority Data
Mar. 29, 2016 (EP) 16162586.8

(51) Int. Cl. H04R 25/00

(52) U.S. Cl. CPC H04R 25/556; H04R 25/402; H04R 2225/021; H04R 2225/025; H04R 2225/63

(57) ABSTRACT

A hearing device comprising a housing is disclosed. The housing is configured to provide for a modular type hearing device. Thus, the housing of the hearing device is configured to receive and be electrically connected to at least a sound guiding element configured to connect a speaker part to the housing of the hearing device, such that the interface between the hearing device housing and the sound guiding element is made generic and as a standard fit, providing the possibility of creating one or more different hearing aid solutions, from a generic housing construction.

### FIELD

The present disclosure relates to a hearing device comprising a housing configured to receive and be electrically connected to a sound guiding element. More particularly, the disclosure relates to a hearing device having a housing that is configured to fit different types of hearing devices.

### BACKGROUND

Several shell sets (i.e. hearing aid housings) are available for hearing aids worn behind the ear. Among these sets one can find the traditional behind-the-ear (BTE) housing, the mini-BTE housing, the receiver-in-the-ear (RITE) housing and the mini-RITE housing. Whereas the BTE shell and the mini-BTE shell have a loudspeaker (also denoted a receiver) arranged in the housing, the loudspeaker is placed outside the housing (in the ear canal) in the hearing devices applying the (RITE) housing and the mini-RITE housing.

The design of the housings for BTE and RITE devices are, however, very similar. The same holds for the mini-BTE housing and the mini-RITE housing. When producing these four types of hearing devices, four different housings are required to be manufactured and assembled.

Accordingly, the dispenser is required to store a large number of housings in order to be able to meet the requirements of customers having different needs.

Therefore, there is a need to provide a hearing device that reduces the required number of housings for meeting the requirements of different customers. The present disclosure provides at least an alternative solution for providing a standard housing (i.e. shell structure) which may be used with different types of hearing aid. As such the disclosure provides for a modular engagement concept suitable for different hearing aids.

### SUMMARY

According to an aspect of the disclosure, the hearing device is a hearing aid comprising a housing having a first set of one or more electrical connection members, and a sound guiding element configured to guide sound from a speaker unit to an in-the-ear part of the hearing aid. The sound guiding element comprises a second set of one or more electrical connection members, and the housing is configured to connect with the second set of one or more electrical connection members of the sound guiding element, thereby providing an electrical connection between the speaker unit and electrical components of the housing. According to the disclosure, the hearing aid is configured such that the speaker unit forms an integrated part of the sound guiding element.

With such a hearing aid, where the sound guiding element has an integrated speaker unit, and a connection interface to a housing, it is possible to make a standard and generic hearing aid housing, which can adapt to any configuration of a sound guiding element having a speaker unit integrated therein. Accordingly, it is possible to provide a hearing device that reduces the number of housings required in order to meet the requirements of different customers, since it allows the hearing care professional to use a generic hearing aid housing to different types of hearing aid types.

According to the disclosure, the housing is configured to receive a sound guiding element and a set of one or more electrical connection members configured to connect a speaker part (i.e. a speaker unit) to the housing of the hearing device, wherein the speaker part is integrated into the sound guiding element. The housing is further configured to be electrically connected to the sound guiding element in that a connection member is provided to electrically connect the speaker part to the housing of the hearing device. In this way, the speaker part when being integrated into the sound guiding element is powered and electrically connected to the hearing aid housing by said connection member.

Accordingly, the housing can be used in various applications and the number of parts for providing hearing devices can be reduced.

In an embodiment, the sound guiding element of the hearing device comprises a first distal end and a second proximal end, wherein the distal should be considered as an end further away from the housing than the second proximal end. Thus, the sound guiding element may in one end distal to the housing be connected to the in-the-ear part and in a second end, proximal to the housing, be connected to a part of the housing. Furthermore, the speaker unit may in said embodiment form an integrated part of the sound guiding element at the second proximal end of the sound guiding element, where the speaker unit is electrically connected to the housing through a connection between the first and second set of electrical connection members. In this way, the speaker is integrated in the sound tube in an area proximate to where the speaker unit connects with the hearing device housing creating a sound tube, which may guide sound in a sufficient manner to the in-the-ear part, while using a generic hearing aid housing.

In accordance herewith, the housing of the hearing device may comprise a number of electrical connection members arranged and configured to receive corresponding electrical connection members provided at the sound guiding element, preferably at the proximal end of the sound guiding element, that is the end connection to the housing of the hearing device.

Hereby, it is possible to establish an electrical connection between the housing and the sound guiding element, for powering and providing electrical signals to the speaker unit. In this way, the sound guiding element can be both mechanically and electrically connected to the housing by means of the electrical connection members.

The first set of the one ore more electrical connection members may according to the disclosure protrude from a first contact surface of the housing, and the corresponding second set of the one or more electrical connection members at a second contract surface provided at the sound guiding element may be configured to be electrically connected to the first set of the one or more electrical connection members protruding from the first contact surface. Hereby, an electrical and mechanical connection between the electrical connection members protruding from the housing and the corresponding electrical connection members provided at the sound guiding element can be established in an easy manner. Moreover, the mechanical and electrical connection between the electrical connection members protruding from the housing and the corresponding electrical connection members provided at the sound guiding element can be disconnected by pulling the housing and the corresponding electrical connection members provided at the sound guiding element from each other. Thus, the electrical connection members of the housing and the corresponding electrical connection members of the sound guiding element may be detachably connected to each other. Furthermore, the electrical connection members may be configured such that the second set of the one or more electrical connection members protrudes from a second contact surface of the sound guiding element, and are configured to electrically connect with the first set of the one or more electrical connection members provided on the housing. Accordingly, it should be understood that the electrical connection members could form a protrusion on either the first contact surface of the housing or the second corresponding contact surface of the sound guiding element. In either case, the the establishment of an electrical and mechanical connection between the housing and the sound guiding element is eased and made generic for a series of different hearing aid types. In addition an eased disconnection is achieved by pulling the housing and the corresponding electrical connection members provided at the sound guiding element or at the housing from each other.

In general, with a hearing device according to the embodiments of the disclosure, it is possible to increase the variety of hearing devices that can be produced by means of a single housing design. By providing a housing design according to the disclosure, it is possible to connect a series of different type sound guiding elements (such as sound hooks or RITE type sound tubes) to the housing. Thus, a modular sound guiding concept is provided for, which make it possible to ease production by minimizing the amount of different housing types produced for different hearing aid types.

Accordingly and as already described, the sound guiding element may comprise an integrated speaker unit. The integrated speaker unit provided in the sound guiding element, for example provides for a separation of the microphone (either situated in the ear mold or in the housing, i.e. shell of the hearing aid), whereby internal feedback problems may be reduced.

In an embodiment of the disclosure, the speaker may be provided in the most proximal end of the sound guiding element. That is, the speaker may be arranged in the end of the sound guiding element closets to the housing (i.e. shell) when connected thereto through the respective electrical connection members.

According to the disclosure, the housing may comprise a first contact surface configured to be brought into contact with a corresponding second contact surface of the sound guiding element or the connection member, wherein the first contact surface has a geometry corresponding to the second contact surface of the sound guiding element.

Hereby, it is possible to provide an abutting contact between the first contact surface and the second contact surface of the sound guiding element. Accordingly, a reliable mechanical connection can be achieved between the housing and the sound guiding element or the connection member.

Furthermore, the housing may comprise a second contact surface configured to be brought into contact with a corresponding third contact surface of the sound guiding element.

Hereby, it is possible to provide an additional abutting contact between the second contact surface and third the contact surface of the sound guiding element or the connection member. Accordingly, an even more reliable mechanical connection can be achieved between the housing and the sound guiding element or the connection member.

In more detail, the first contact surface of said housing may comprise a concave shaped surface, which concave surface is configured to alight with and connect to a corresponding convex surface of the second contact surface of the sound guiding element. This shaping allows for an easy alignment between the sound guiding element and the housing, since the geometrical matching surfaces creates a one-fit and generic interface between the housing and the sound guiding element. In a further embodiment, the housing comprises at least three contact surfaces, wherein each of the three contact surfaces are configured to connect and align with corresponding three contact surfaces of the sound guiding element. The additional contact surfaces allow for a secure attachment between the housing and the sound guiding element. That is, the three contact surfaces creates not only a guiding construction, by which the sound guiding element is guiding into place on the housing, but also allows for mechanical attachment elements on a larger area creating said secure connection.

Accordingly, in an embodiment, the housing comprises in a longitudinal direction a third contact surface, which is configured with a bend. Each side of the bend along the longitudinal extension of the housing is configured as a guiding contact surface, which receives a corresponding bended third contact surface of the sound guiding element. This ensures that the sound guiding element is correctly and easy guided into place on the electrical connection members, such that a correct attachment between the electrical connection members is achieved.

In addition to the previous mentioned attachment mechanism between the housing and the sound guiding element, the, the housing may also be provided with an engagement member configured to engage with a corresponding engagement member provided in the sound guiding element.

Hereby, it is possible to use the corresponding engagement members to guide the mechanical connection and secure that the housing and the sound guiding element or the housing and the connection member are connected in the correct manner.

Accordingly, according to the disclosure, the engagement member may protrude from a contact surface of the housing, wherein the corresponding engagement member provided in the sound guiding element comprises a groove-shaped portion. Hereby, the protruding engagement member can be inserted into the corresponding groove-shaped portion. Accordingly, the mechanical connection of the sound guiding element or in the connection member into the housing is eased. It should be noted that the groove shaped portion could be provided in either a contact surface of the sound guiding element or in a contact surface of the housing.

The disclosure preferably relates to a hearing aid, which comprises a microphone configured to transform a received ambient sound into an electrical input signal, where a signal processor is configured to process the electrical input signal into a processed electrical data signal, allowing transformation of sound received from the surroundings into an electrical input signal and process this electrical input signal into a processed electrical data signal by means of the signal processor. The signal processing unit may preferably be implemented with at least data mapping of a hearing loss to process the incoming ambient sound picked up by the microphone, to an electrical signal suitable for compensating a hearing loss of the user of the hearing aid. The hearing device may comprise an omnidirectional microphone and/or a directional microphone. The hearing device may comprise more microphones.

According to the disclosure, the microphone may be arranged in the housing. Additional a second microphone may be arranged in the ear piece (also denoted in-the-ear part), such as an earmold and/or dome of the hearing aid. By arranging the microphone in the proximity of the ear canal, it is possible to take into account the natural function of the pinna, and thereby improve the spatial cues perceived by the hearing aid user. This improving the hearing aid experience of the user by providing a more natural perception of the ambient surrounding sounds.

In a further embodiment of the disclosure, the microphone may also be arranged in the sound guiding element or e.g. in the in-the-ear part. That is one or more microphones could be arranged in one or more different parts of the hearing aid. Accordingly, in an embodiment of the disclosure, one microphone could be arranged in the housing, sound guiding element or connection member and another microphone could be arranged in the ear mold, this providing at least two microphones.

The microphone may also be provided at said in-the-ear part arranged at the distal end of the sound guiding element in such a manner that the microphone is provided substantially at or in the ear canal when the in-the-ear part is arranged in the ear canal.

It should be noted that the sound guiding element preferably should be construed as a being formed as a hook configured to be at least partly arranged behind the ear of a user and wherein the speaker unit forms an integrated part of the hook. Accordingly, the hook forms the interface between the generic housing shell of the hearing aid and a sound tube guiding sound from the speaker unit integrated in the hook to the earpiece.

### BRIEF DESCRIPTION OF DRAWINGS

The aspects of the disclosure may be best understood from the following detailed description taken in conjunction with the accompanying figures. The figures are schematic and simplified for clarity, and they just show details to improve the understanding of the claims, while other details are left out. Throughout, the same reference numerals are used for identical or corresponding parts. The individual features of each aspect may each be combined with any or all features of the other aspects. These and other aspects, features and/or technical effects will be apparent from and elucidated with reference to the illustrations described hereinafter in which:

FIG. 1 shows a schematic side view of a hearing device according to an embodiment of the disclosure;

FIG. 2 shows another schematic view of the hearing device shown in FIG. 1;

FIG. 3 shows a schematic side view of a hearing device according to an embodiment of the disclosure;

FIG. 4 shows another schematic view of the hearing device shown in FIG. 3;

FIG. 5 shows a close-up view of the housing and connection member of the hearing device shown in FIG. 3 and FIG. 4;

FIG. 6 shows a schematic side view of a hearing device according to an embodiment of the disclosure;

FIG. 7 shows another schematic view of the hearing device shown in FIG. 6;

FIG. 8 shows a schematic side view of a hearing device according to an embodiment of the disclosure;

FIG. 9 shows another schematic view of the hearing device shown in FIG. 8;

FIG. 10 shows a schematic side view of a hearing device according to an embodiment of the disclosure;

FIG. 11 shows another schematic view of the hearing device according to an embodiment of the disclosure

FIG. 12 shows a schematic side view of a hearing device according to an embodiment of the disclosure and

FIG. 13 shows a schematic view of the hearing device according to another embodiment of the disclosure.

### DETAILED DESCRIPTION

The detailed description set forth below in connection with the appended drawings is intended as a description of various configurations. The detailed description includes specific details for the purpose of providing a thorough understanding of various concepts. However, it will be apparent to those skilled in the art that these concepts may be practised without these specific details. Several aspects of the apparatus and methods are described by various blocks, functional units, modules, components, circuits, steps, processes, algorithms, etc. (collectively referred to as “elements”). Depending upon particular application, design constraints or other reasons, these elements may be implemented using electronic hardware, computer programs, or any combination thereof.

The electronic hardware may include microprocessors, microcontrollers, digital signal processors (DSPs), field programmable gate arrays (FPGAs), programmable logic devices (PLDs), gated logic, discrete hardware circuits, and other suitable hardware configured to perform the various functionality described throughout this disclosure. Computer programs shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

A hearing device may include a hearing aid that is adapted to improve or augment the hearing capability of a user by receiving an acoustic signal from a user's surroundings, generating a corresponding audio signal, possibly modifying the audio signal and providing the possibly modified audio signal as an audible signal to at least one of the user's ears. The “hearing device” may further refer to a device such as an earphone or a headset adapted to receive an audio signal electronically, possibly modifying the audio signal and providing the possibly modified audio signals as an audible signal to at least one of the user's ears. Such audible signals may be provided in the form of an acoustic signal radiated into the user's outer ear, or an acoustic signal transferred as mechanical vibrations to the user's inner ears through bone structure of the user's head and/or through parts of the middle ear of the user or electric signals transferred directly or indirectly to the cochlear nerve and/or to the auditory cortex of the user.

The hearing device is adapted to be worn in any known way. This may include i) arranging a unit of the hearing device behind the ear with a tube leading air-borne acoustic signals into the ear canal or with a receiver/loudspeaker arranged close to or in the ear canal such as in a Behind-the-Ear type hearing aid, and/or ii) arranging the hearing device entirely or partly in the pinna and/or in the ear canal of the user such as in an In-the-Ear type hearing aid or In-the-Canal/Completely-in-Canal type hearing aid.

A “hearing system” refers to a system comprising one or two hearing devices, and a “binaural hearing system” refers to a system comprising two hearing devices where the devices are adapted to cooperatively provide audible signals to both of the user's ears. The hearing system or binaural hearing system may further include auxiliary device(s) that communicate with at least one hearing device, the auxiliary device affecting the operation of the hearing devices and/or benefitting from the functioning of the hearing devices. A wired or wireless communication link between the at least one hearing device and the auxiliary device is established that allows for exchanging information (e.g. control and status signals, possibly audio signals) between the at least one hearing device and the auxiliary device. Such auxiliary devices may include at least one of the following: remote controls, remote microphones, audio gateway devices, mobile phones, public-address systems, car audio systems or music players or a combination thereof. The audio gateway is adapted to receive a multitude of audio signals such as from an entertainment device like a TV or a music player, a telephone apparatus like a mobile telephone or a computer, a PC. The audio gateway is further adapted to select and/or combine an appropriate one of the received audio signals (or combination of signals) for transmission to the at least one hearing device. The remote control is adapted to control functionality and operation of the at least one hearing devices. The function of the remote control may be implemented in a SmartPhone or other electronic device, the SmartPhone/electronic device possibly running an application that controls functionality of the at least one hearing device.

In general, a hearing device includes i) an input unit such as a microphone for receiving an acoustic signal from a user's surroundings and providing a corresponding input audio signal, and/or ii) a receiving unit for electronically receiving an input audio signal. The hearing device further includes a signal processing unit for processing the input audio signal and an output unit for providing an audible signal to the user in dependence on the processed audio signal.

The input unit may include multiple input microphones, e.g. for providing direction-dependent audio signal processing. Such a directional microphone system is adapted to enhance a target acoustic source among a multitude of acoustic sources in the user's environment. In one aspect, the directional system is adapted to detect (such as adaptively detect) from which direction a particular part of the microphone signal originates. This may be achieved by using conventionally known methods. The signal processing unit may include an amplifier that is adapted to apply a frequency dependent gain to the input audio signal. The signal processing unit may further be adapted to provide other relevant functionality such as compression, noise reduction, etc. The output unit may include an output transducer such as a loudspeaker/receiver for providing an air-borne acoustic signal transcutaneously or percutaneously to the skull bone or a vibrator for providing a structure-borne or liquid-borne acoustic signal. In some hearing devices, the output unit may include one or more output electrodes for providing the electric signals such as in a Cochlear Implant.

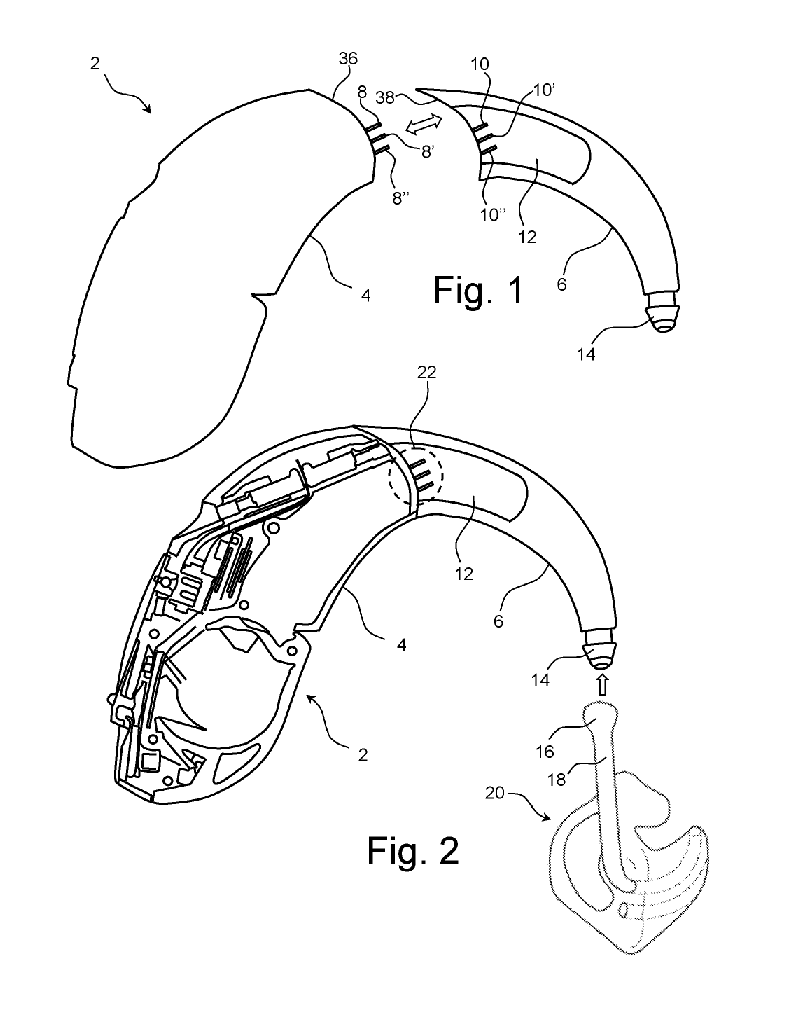

Now referring to FIG. 1, which illustrates a schematic side view of a hearing aid 2 according to aspect of the disclosure. The hearing aid 2 comprises a housing 4 and a sound guiding element 6, in the embodiment shown in FIG. 1 formed as a sound hook.

The housing 4 is provided with a first contact surface 36 adapted to receive a corresponding second contact surface 38 of the sound hook 6. A plurality of connection members 8, 8′, 8″ (such as electrical connection members) protrude from the contact surface 36. The electrical connection members 8, 8′, 8″ are formed as parallel pins extending basically perpendicular to the contact surface 36 of the housing 4. As seen on FIGS. 1 and 2, the hearing aid 2 may comprises on the housing 4 three connection members 8, 8′, 8″ and the sound hook 6 comprises three corresponding electrical connection members 10, 10′, 10″. Accordingly, the three connection members of the sound hook and the housing are configured to electrically connect with each other to provide electrical connection to a speaker unit 12 integrated into the sound hook.

It should however be noted that at least one connection member would be suitable and would fall within the scope of the disclosure. Thus, one or more connection members could be provided.

The sound hook 6 is as seen in the Figures provided with a speaker unit 12 which is integrated in the proximal end of the sound hook 6. A plurality of electrical connection members 10, 10′, 10″ is configured to receive the connection members 8, 8′, 8″ of the housing 4 are provided in the free end of the speaker unit 12.

In FIG. 1, the housing 4 and the sound hook 6 are separated from each other, however, it can be seen that the housing 4 and the sound hook 6 can be electrically and mechanically connected by inserting the pin-shaped connection members 8, 8′, 8″ into the corresponding tube-shaped electrical connection members 10, 10′, 10′ of the sound tube 6.

In essence, the geometry of the connection members of the sound guiding element and the housing should be designed to geometrically match each other in any suitable manner, such as to provide for a key and a lock mechanism.

As seen in FIG. 2, wherein the housing 4 and the sound hook 6 have been electrically and mechanically connected to each other, the first contact surface 36 of the housing 4 has a geometry that corresponds to the geometry of the second contact surface 38 of the sound hook 6. Accordingly, the first contact surface 36 of the housing 4 and the second contact surface 38 of the sound hook 6 are in a mounted condition construed as abutting contact surfaces. As may be seen form the figures the contact surface thus have corresponding geometrical shaped, in this cases provided as a concave and a convex surface which aligns with each when the sound hook is connected to the housing. With such shaping of the interface between the housing and the sound guiding element (in this case the sound hook), a generic housing of the hearing aid can be allowed for while, a plurality of different “designs” of the sound guide element is possible, as long as the interface to the generic housing first contact surface 36 is maintained.

FIG. 2 also illustrates a sound hook tip 14, which is provided in the distal end of the sound hook 6. In FIG. 2, it can be seen that the sound hook 6 is configured to receive an earmould 20 provided with an earmold pipe 18 having an earmold tip 16. The earmould tip 16 is shaped and configured to be mechanically attached to the sound hook tip 14 of the sound hook 6. That is, the sound hook tip is in a first proximal end (closets to the housing) interfacing the housing, wherein the sound hook tip in a second distal end may interface a plurality of different sound guiding means, such as a sound tube or e.g. an ear mold as described in relation to FIG. 2.

It should be noted other types of earmold than shown in FIG. 2 is suitable for connection with a sound guiding element, such as the sound hook illustrated in FIG. 2. That is a custom made earmold, a dome shaped ear tip or any other suitable kind of ear piece construction could in a similar manner be connected with the sound guiding element, as will become apparent throughout the disclosure.

The housing comprises an audio processor comprising a microphone configured to transform a received sound into an electrical input signal and a signal processor configured to process the electrical input signal into a processed electrical data signal. The processed electrical data signal is received by the speaker unit 12 that provides an air-borne acoustic signal (sound waves) that are routed acoustically to the ear of a user via the sound hook 6 and the earmould 20.

In an embodiment (not shown) it should be noted that at least one microphone could also be arranged in the sound guiding element 6. Thus, it is possible to arrange at least one microphone in the housing and/or a microphone in the sound guiding element 6.

As indicated in FIGS. 1 and 2, the speaker unit is forming an integrated part of the sound guiding element (i.e. the sound hook 6). That is, the speaker unit 12 is arranged in the sound hook 6 and is electrically connected with the housing 4 through the electrical connection members 8, 8′, 8″ of the housing and the corresponding electrical connection members 10, 10′, 10″ of the sound hook 6. The connection of the sound hook 6 to the housing 4 is more clearly illustrated in FIG. 2, by the dotted circle 22, where it is seen that the respective electrical connection members fit into each other.

FIG. 3 illustrates a schematic side view of a hearing device 2 according to an embodiment of the disclosure. The hearing device 2 comprises a housing that basically corresponding to the housing shown in FIG. 1 and FIG. 2. The housing 4 comprises a contact surface 36 configured to receive a corresponding contact surface 38 of a connection member 30 illustrated next to the housing. The connection member 30 creates the interface to the housing, and as is seen from the figures comprises a matching geometrical shape to the first contact surface of the housing, while also having electrical connection members arranged thereon.

A plurality of parallel electrical connection members 8, 8′, 8″ protrude from the contact surface 36. The electrical connection members 8, 8′, 8″ are shaped as parallel pins extending essentially perpendicular to the contact surface 36 of the housing 4.

A tube 28 provided with a speaker 26 in its proximal end is attached to the connection member 30. The speaker being arranged in the distal end of the tube in relation with the ear piece is thus configured to be inserted into the ear canal of a user. A dome 24 has been attached to a part of the speaker 26.

Furthermore, illustrated in FIG. 3, a plurality of electrical connection members 10, 10′, 10″ adapted for receiving the electrical connection members 8, 8′, 8″ of the housing 4 are provided in the free end of the connection member 30. In one embodiment of a hearing device 2 according to the disclosure, the housing 4 comprises three connection members 8, 8′, 8″ and the connection member 30 comprises three corresponding electrical connection members 10, 10′, 10″.

Accordingly, the embodiments of FIGS. 1, 2 and FIGS. 3, 4 all show a generic interface between a hearing aid housing and a sound guiding element, which allows for a single standard housing that can be used with a plurality of hearing aid solutions, such as RITE, BTE and so forth, as long a connection interface matching the generic standard housing is provided for.

For providing an efficient mechanical attachment between the housing and the sound guiding element, a groove-shaped engagement member 48 is provided in the contact surface 36 of the housing 4. This groove-shaped engagement member 48 is configured to receive a corresponding engagement member 50 protruding from the contact surface 38 of a connection member 30. Even though not illustrated in FIGS. 1 and 2, it should be noted that such groove-shaped engagement member cold similarly be used for guiding and connection elements in the embodiments of FIGS. 1 and 2.

The connection member 30 is adapted to be engage with the housing 4 in a manner in which the electrical connection members 8, 8′, 8″ are engagingly received by the corresponding electrical connection members 10, 10′, 10″ and in which the engagement member 50 protruding from the contact surface 38 has been engagingly received by the groove-shaped engagement member 48 provided in the contact surface 36.

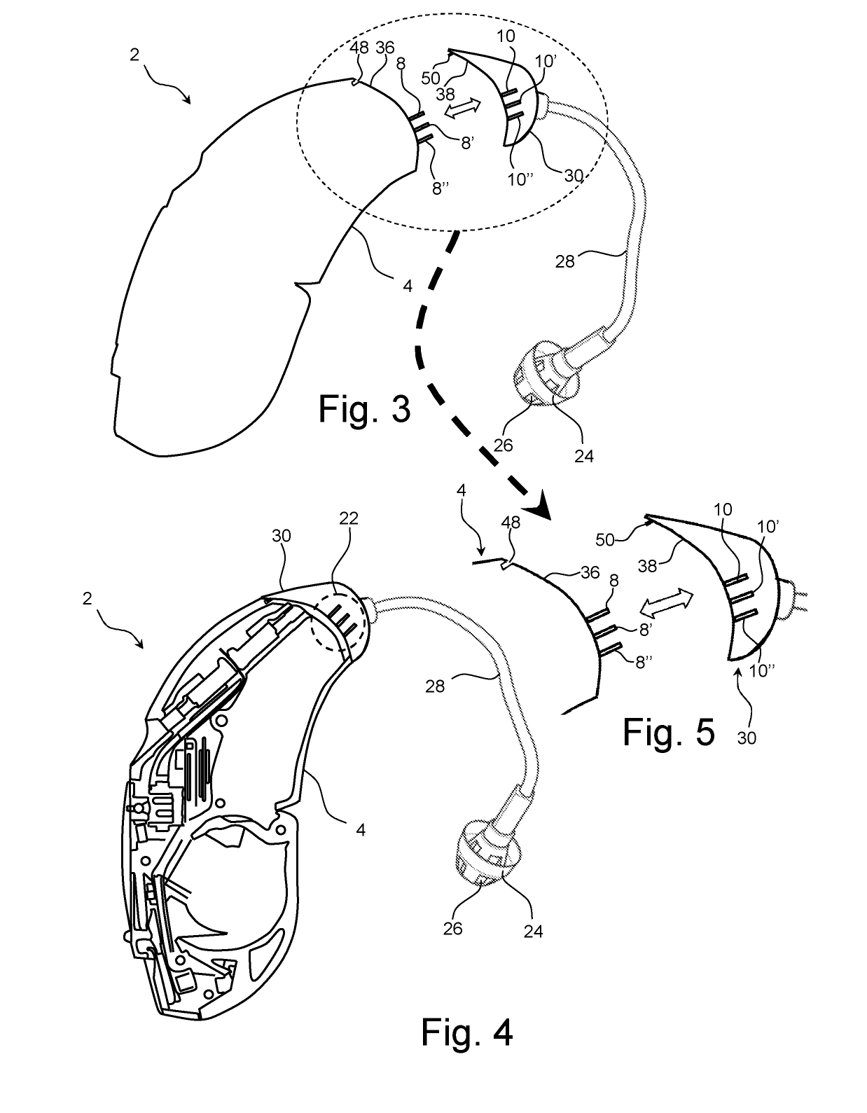

FIG. 4 illustrates another schematic view of the hearing device 2 shown in FIG. 3. The connection member 30 has been attached to the housing 4 and thus an electrical connection 22 has been established.

In general, the electrical connection 22 between the housing 4 and the sound guiding element (such as the sound hook or sound tube shown in the embodiments of FIGS. 1 to 3) provides for sufficient electric supply for the hearing aid to function properly, i.e. providing electrical connection to at least the speaker unit.

In accordance with the embodiments of FIGS. 3 and 4, a microphone (not shown) is arranged in the housing and/or in the connection member 30. In addition and apparent throughout the description one or more microphones may be arranged in the housing, connection member and/or ear piece. This should be understood to be apply for all of the described embodiments.

FIG. 5 illustrates a close-up view of the housing 4 and connection member 30 of the hearing device 2 shown in FIG. 3 and FIG. 4. It can be seen that the housing 4 comprises a convex contact surface 36 and that the connection member 30 comprises a corresponding concave contact surface 38 configured to receive the convex contact surface 36 of the housing 4. A groove-shaped engagement member 48 is provided in the contact surface 36. The groove-shaped engagement member 48 is adapted to receive a corresponding engagement member 50 protruding from the contact surface 38 of a connection member 30. The connection member 30 is adapted to engage with the housing 4 in a manner in which the electrical connection members 8, 8′, 8″ protruding from the contact surface 36 are engagingly received by the corresponding electrical connection members 10, 10′, 10″ provided in the contact surface 38 of the connection member 30. The engagement member 50 protruding from the contact surface 38 is shaped and configured to be engagingly received by the groove-shaped engagement member 48 provided in the contact surface 36.

Comparing FIG. 1 and FIG. 3, it can be seen that the housing 4 can be used to receive both a sound guiding element 6 formed as a sound hook 6 and a sound guiding element formed as the connection member 30 shown in FIG. 2. Accordingly, by applying the housing 4, it is possible to provide a BTE-type hearing device (see FIG. 1) and a RITE-type hearing device (see FIG. 3).

Thus, according to the disclosure it is possible to design a single housing structure 4, which are suitable for connection with different types of sound guiding elements. Limiting the housing to a single design element that can be used for different kind of hearing aid types provides for an easy production and limits the potential stock of housings (i.e. shells) which a dispenser would be inclined to store in order to be able to support all kinds of user needs. As previously elaborated on, it is however important that the first contact surface of the housing and the second contact surface of the connection element is designed geometrically to match each other. In this way, one housing can be made to fit a plurality of different hearing aid attachments, such as sound guides, ear molds etc.

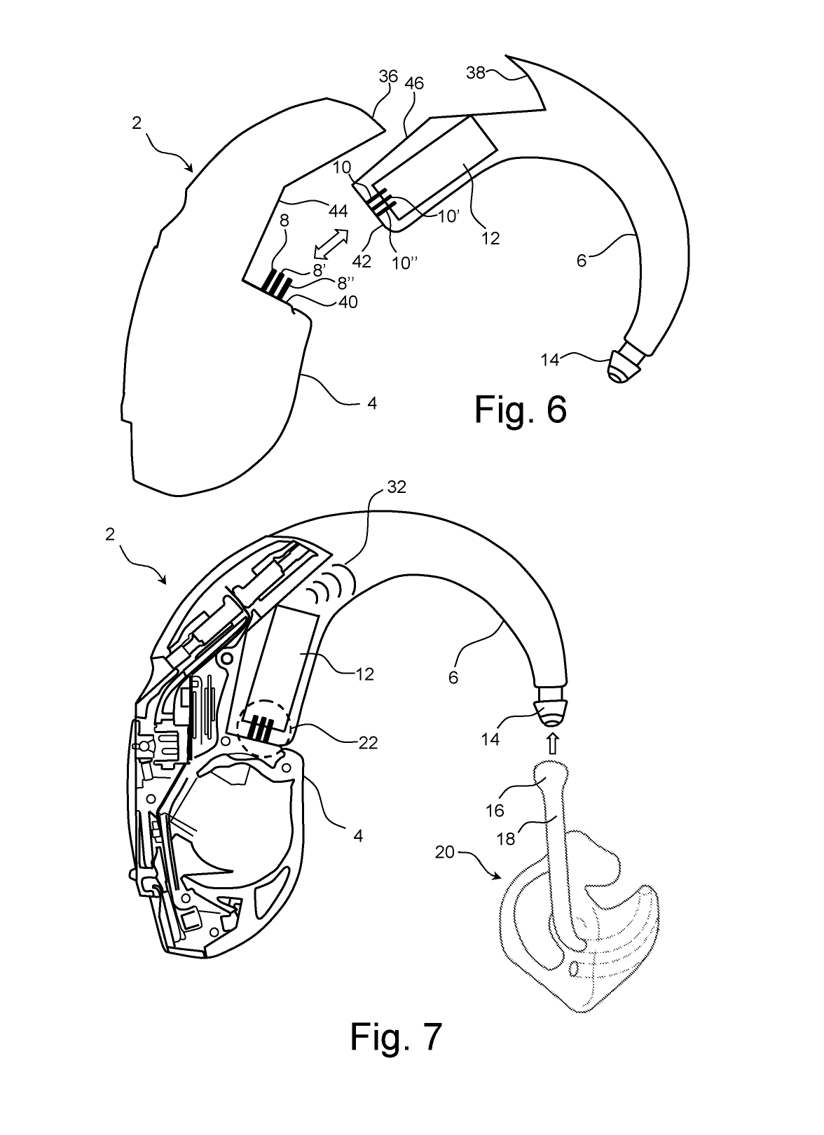

FIG. 6 illustrates a schematic side view of a hearing device 2 according to an embodiment of the disclosure. The hearing device 2 comprises a housing 4 and a sound guiding element 6 formed as a sound hook 6. The housing 4 is provided with a first contact surface 36 adapted to receive a corresponding first contact surface 38 of the sound hook 6. The housing 4 is further provided with a second contact surface 40 adapted to receive a corresponding second contact surface 42 of the sound hook 6. The housing 4 is further provided with a third contact surface 44 adapted to receive a corresponding third contact surface 46 of the sound hook 6.

A plurality of electrical connection members 8, 8′, 8″ protrude from the contact surface 36. The electrical connection members 8, 8′, 8″ are formed as parallel pins extending basically perpendicular to the second contact surface 40 and essentially parallel to the third contact surface 44 of the housing 4.

The sound hook 6 is provided with a speaker 12 provided in the proximal end of the sound hook 6. A plurality of electrical connection members 10, 10′, 10″ configured to receive the connection members 8, 8′, 8″ of the housing 4 extend from the free end of the speaker 12 towards the free end of the sound hook 6 through the second contact surface 42 of the sound hook 6. In one embodiment of a hearing device 2 according to the disclosure, the housing 4 comprises three connection members 8, 8′, 8″, and the sound hook 6 comprises three corresponding electrical connection members 10, 10′, 10″.

As seen in FIGS. 6 and 7, the housing 4 comprises at least three contact surfaces 44, 40 and 36, wherein each of said three contact surfaces are configured to connect and align with corresponding three contact surfaces 46, 42, 38 of said sound guiding element. Furthermore, also illustrated in FIGS. 6 and 7, is how the contact surface 44 and 46 is divided into two sections, which sections together forms a bend on the housing and the sound hook, respectively. This bend on the housing extends along the extension of the housing and is configured as a guiding contract surface, such that upon mounting the sound hook 6 to the housing 4, a one-way fit is achieved, since the two bends have to fit together for providing a secure connection between the housing and the sound hook 6. Furthermore, the larger surface area connecting the sound hook and the housing provides a more stable mechanical connection.

The housing 4 and the sound hook 6 are separated from each other and it can be seen that the housing 4 and the sound hook 6 can be electrically and mechanically connected by inserting the pin-shaped connection members 8, 8′, 8″ into the corresponding tube-shaped electrical connection members 10, 10′, 10′ of the sound tube 6.

In FIG. 7, the housing 4 and the sound hook 6 are electrically and mechanically connected to each other. Accordingly, the first contact surface 36 of the housing 4 bears against the first contact surface 38 of the sound hook 6. Likewise, the second contact surface 40 of the housing 4 bears against the second contact surface 42 of the sound hook 6 and the third contact surface 44 of the housing 4 bears against the third contact surface 46 of the sound hook 6. Accordingly, the housing 4 has a geometry that makes it configured to engagingly receive the sound hook 6.

A sound hook tip 14 is provided in the distal end of the sound hook 6. It can be seen that the sound hook 6 is configured to receive an earmould 20 provided with an earmould pipe 16 having an earmould tip 16. The earmould tip 16 is shaped and configured to be mechanically attached to the sound hook tip 14 of the sound hook 6.

The housing 4 is equipped with an audio processor device comprising a microphone adapted to transform a received sound into an electrical input signal and a signal processor configured to process the electrical input signal into a processed electrical data signal. This processed electrical data signal is received by the speaker 12 which provides an air-borne acoustic signal (sound waves) that are routed acoustically or to the ear via the sound hook 6 through the sound hook tip 6, the earmould pipe 18 and the earmould 20.

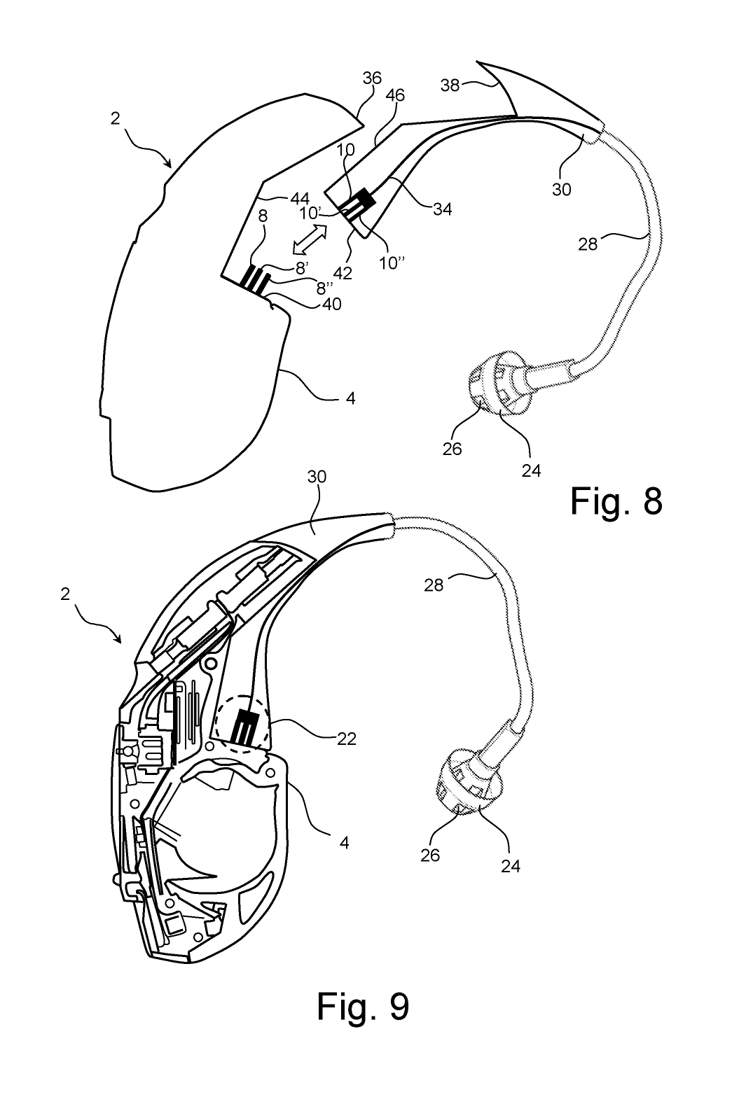

FIG. 8 illustrates a schematic side view of a hearing device 2 according to an embodiment of the disclosure, and FIG. 9 illustrates another schematic view of the hearing device shown in FIG. 8. The hearing device 2 is a RITE hearing device 2 comprising a housing 4 and a sound guiding element formed as a connection member 30. In FIG. 8, the connection member 30 is separated from the housing 4, whereas the connection member 30 is attached to the housing 4 in FIG. 9.

A tube 28 provided with a speaker 26 in its proximal end is attached to the connection member 30. A dome 24 is attached to the speaker 26. A plurality of pin-shaped electrical connection members 10, 10′, 10″ adapted for being inserted into corresponding tube-shaped electrical connection members 8, 8′, 8″ of the housing 4 are provided in the free end of the connection member 30. In one embodiment of a hearing device 2 according to the disclosure, the housing 4 comprises three connection members 8, 8′, 8″ and the connection member 30 comprises three corresponding electrical connection members 10, 10′, 10″. A cable 34 connects the electrical connection members 10, 10′, 10″ and the speaker 26.

The housing 4 is provided with a first contact surface 36 adapted to receive a corresponding first contact surface 38 of the connection member 30. The housing 4 is further provided with a second contact surface 40 adapted to receive a corresponding second contact surface 42 of the connection member 30. The housing 4 is provided with a third contact surface 44 adapted to receive a corresponding third contact surface 46 of the connection member 30.

The plurality of electrical connection members 8, 8′, 8″ are protruding from the second contact surface 40. The electrical connection members 8, 8′, 8″ are shaped as parallel tube-shaped extending essentially parallel to the third contact surface 44 of the housing 4.

FIG. 9 illustrates a view in which the connection member 30 has been attached to the housing 4. Accordingly, an electrical connection 22 has been established between the connection member 30 and the housing 4.

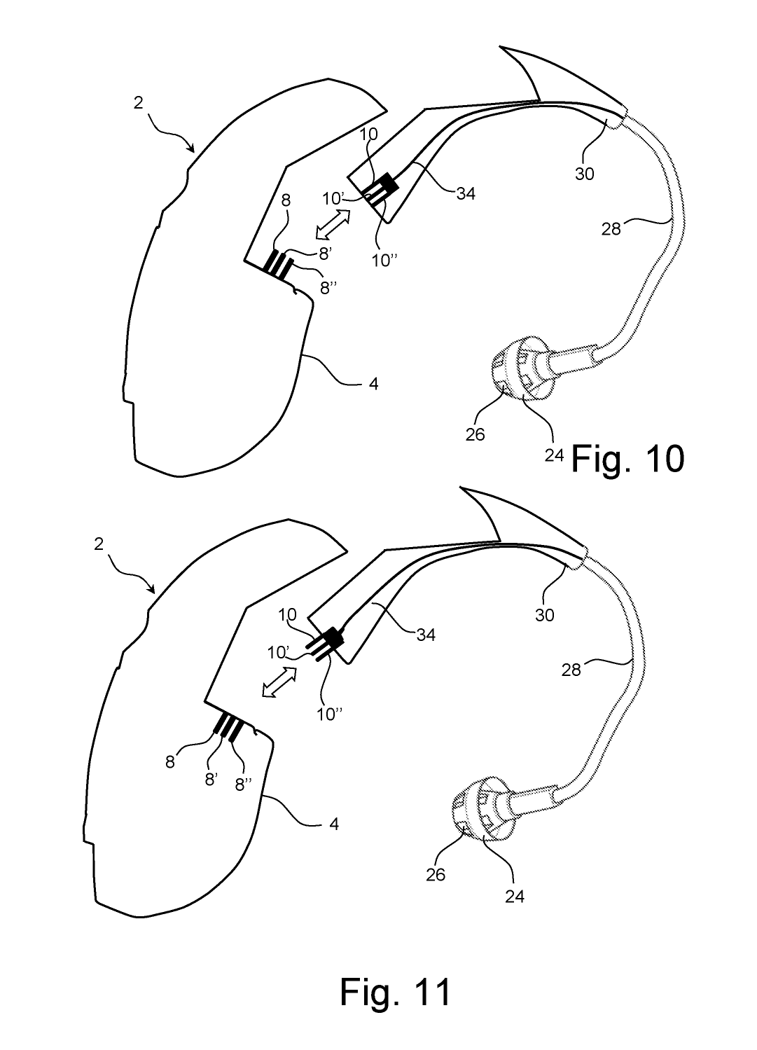

FIG. 10 illustrates a schematic side view of a hearing device 2 according to an embodiment of the disclosure corresponding to the one shown in FIG. 8.

FIG. 11 illustrates a schematic view of the hearing device 2 according to an embodiment of the disclosure. The hearing device 2 comprises a housing 4 provided with a plurality of electrical connection members 8, 8′, 8″ formed as tube-shaped structures extending into the interior of the housing 4. The hearing device 2 comprises a connection member 30 provided with a plurality of pin-shaped electrical connection members 10, 10′, 10″ protruding from the free end of the connection member 30. The electrical connection members 10, 10′, 10″ are configured to be inserted into the corresponding tube-shaped electrical connection members 8, 8′, 8″.

The housing 4 and the connection member 30 is provided with the same surface structures as explained with reference to FIG. 8. Accordingly, the connection member 30 is adapted to be engagingly received by and attached to the housing 4.

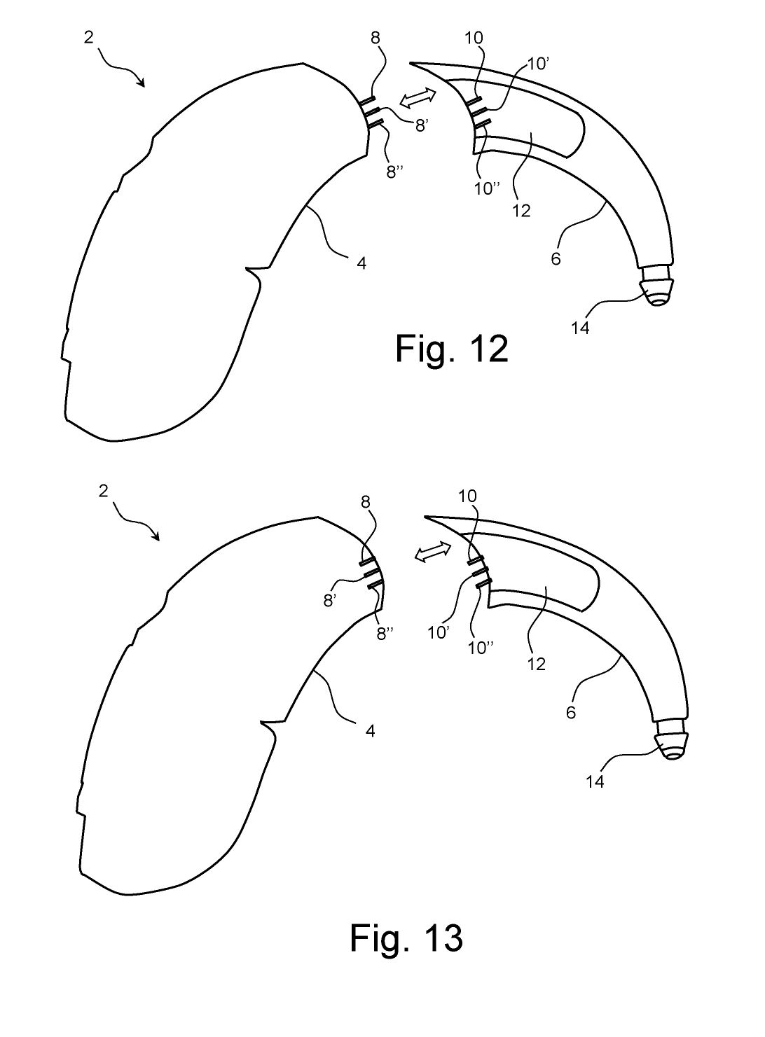

FIG. 12 illustrates a schematic side view of a hearing device 2 according to an embodiment of the disclosure. The hearing device 2 corresponds to the hearing device shown in FIG. 1.

FIG. 13 illustrates a schematic view of the hearing device 2 according to an embodiment of the disclosure. The hearing device 2 comprises a housing 4 provided with a plurality of electrical connection members 8, 8′, 8″ formed as tube-shaped structures extending into the interior of the housing 4. The hearing device 2 comprises a sound guiding element 6 shaped as a sound hook 6 provided with a plurality of pin-shaped electrical connection members 10, 10′, 10″ protruding from the free end of the speaker 12 of the sound hook 6. The electrical connection members 10, 10′, 10″ are configured to be inserted into the corresponding tube-shaped electrical connection members 8, 8′, 8″ of the housing 4.

As used, the singular forms “a,” “an,” and “the” are intended to include the plural forms as well (i.e. to have the meaning “at least one”), unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will also be understood that when an element is referred to as being “connected” or “coupled” to another element, it can be directly connected or coupled to the other element, but an intervening elements may also be present, unless expressly stated otherwise. Furthermore, “connected” or “coupled” as used herein may include wirelessly connected or coupled. As used herein, the term “and/or” includes any and all combinations of one or more of the associated listed items. The steps of any disclosed method is not limited to the exact order stated herein, unless expressly stated otherwise.

It should be appreciated that reference throughout this specification to “one embodiment” or “an embodiment” or “an aspect” or features included as “may” means that a particular feature, structure or characteristic described in connection with the embodiment is included in at least one embodiment of the disclosure. Furthermore, the particular features, structures or characteristics may be combined as suitable in one or more embodiments of the disclosure. The previous description is provided to enable any person skilled in the art to practice the various aspects described herein. Various modifications to these aspects will be readily apparent to those skilled in the art, and the generic principles defined herein may be applied to other aspects.

The claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more.

Accordingly, the scope should be judged in terms of the claims that follow.

1. A hearing device comprising
a housing having a first set of one or more electrical connection members, and
a sound guiding element configured to guide sound from a speaker unit to an in-the-ear part of said hearing aid, said sound guiding element comprising a second set of one or more electrical connection members,
wherein the housing is configured to connect with said second set of one or more electrical connection members of said sound guiding element, so as to provide an electrical connection between said speaker unit and electrical components of the housing, and
wherein said speaker unit forms an integrated part of said sound guiding element.

2. A hearing device according to claim 1, wherein
said sound guiding element in one end distal to said housing is connected to said in-the-ear part and in a second end proximal to said housing is connected to a part of the housing,
wherein said speaker unit forms said integrated part of said sound guiding element at said second proximal end of said sound guiding element, and is electrically connected to said housing through a connection between said first and second set of electrical connection members.

3. A hearing device according to claim 1, wherein the sound guiding element is formed as a hook configured to be at least partly arranged behind the ear of a user and wherein said speaker unit forms an integrated part of said hook.

4. A hearing device according to claim 1, wherein the first set of said one or more electrical connection members protrude from a first contact surface of the housing and the corresponding second set of said one or more electrical connection members provided at a second contact surface of the sound guiding element are configured to be electrically connected to the first set of said one or more electrical connection members protruding from said first contact surface.

5. A hearing device according to claim 1, wherein the second set of said one or more electrical connection members protrude from a second contract surface of the sound guiding element and are configured to be electrically connected to the first set of said one or more electrical connection members of a first contact surface of said housing.

6. A hearing device according to claim 1, wherein said first contact surface of said housing is configured to be brought into contact with said second contact surface of the sound guiding element, wherein the first contact surface has a geometry corresponding to the contact surface of the sound guiding element.

7. A hearing device according to claim 1, wherein the housing is provided with at least one first engagement member configured to engage with a at least one corresponding second engagement member provided in the sound guiding element.

8. A hearing device according to claim 7, wherein the at least one first engagement member protrudes from said first contact surface of the housing, and wherein said corresponding at least one second engagement member provided in the sound guiding element comprises a groove-shaped portion.

9. A hearing device according to claim 7, wherein said at least one first engagement member is provided in the sound guiding element and protrudes from said second contact surface of the sound guiding element, and wherein said corresponding second engagement member of said first contact surface of the housing comprises a groove-shaped portion.

10. A hearing device according to claim 4, wherein said first contact surface of said housing comprising a concave shaped surface, which concave surface is configured to align with and connect to a corresponding convex surface of said second contact surface of said sound guiding element.

11. A hearing device according to claim 1, wherein said housing comprises at least three contact surfaces, wherein each of said three contact surfaces are configured to connect and align with corresponding three contact surfaces of said sound guiding element.

12. Hearing device according to claim 11, wherein said housing in a longitudinal direction of said housing at said third contact surface comprises a bend, wherein each side of the bend along the extension of the housing is configured as a guiding contact surface, configured to receive a corresponding bend on said third contact surface of said sound guiding element.

13. A hearing device according to claim 1, wherein a microphone is provided at said in-the-ear part arranged at said distal end of the sound guiding element in such a manner that said microphone is provided substantially at or in the ear canal when the in-the-ear part is arranged in the ear canal.

14. A hearing device according to claim 1, wherein the hearing device is configured as a hearing aid.

15. A hearing device according to claim 2, wherein the sound guiding element is formed as a hook configured to be at least partly arranged behind the ear of a user and wherein said speaker unit forms an integrated part of said hook.

16. A hearing device according to claim 2, wherein the first set of said one or more electrical connection members protrude from a first contact surface of the housing and the corresponding second set of said one or more electrical connection members provided at a second contact surface of the sound guiding element are configured to be electrically connected to the first set of said one or more electrical connection members protruding from said first contact surface.

17. A hearing device according to claim 3, wherein the first set of said one or more electrical connection members protrude from a first contact surface of the housing and the corresponding second set of said one or more electrical connection members provided at a second contact surface of the sound guiding element are configured to be electrically connected to the first set of said one or more electrical connection members protruding from said first contact surface.

18. A hearing device according to claim 2, wherein the second set of said one or more electrical connection members protrude from a second contract surface of the sound guiding element and are configured to be electrically connected to the first set of said one or more electrical connection members of a first contact surface of said housing.

19. A hearing device according to claim 3, wherein the second set of said one or more electrical connection members protrude from a second contract surface of the sound guiding element and are configured to be electrically connected to the first set of said one or more electrical connection members of a first contact surface of said housing.

20. A hearing device according to claim 4, wherein the second set of said one or more electrical connection members protrude from a second contract surface of the sound guiding element and are configured to be electrically connected to the first set of said one or more electrical connection members of a first contact surface of said housing.
